(19) United States
(12) Patent Application Publication
(10) Pub. No.: US 2013/0044795 A1
(43) Pub. Date: Feb. 21, 2013

(54) SYSTEM AND METHOD FOR AUTOMATIC BAUD RATE SELECTION FOR FACSIMILE TRANSMIT AND RECEIVE

(71) Applicant: Steven J. Busak, Gold Canyon, AZ (US)

(72) Inventor: Steven J. Busak, Gold Canyon, AZ (US)

(21) Appl. No.: 13/214,123

(22) Filed: Aug. 19, 2011

(51) Int. Cl. H04B 1/38

(52) U.S. Cl. 375/222

(57) ABSTRACT

A system for automatic data rate selection. A transmit rate control selects a transmit baud rate and a transmit modulation protocol and modifies the transmit baud rate and the transmit modulation protocol in response to communication errors. A receive rate control selects a receive baud rate and a receive modulation protocol and modifies the receive baud rate and the receive modulation protocol in response to communication errors. The transmit baud rate can be modified independent of the transmit modulation protocol, the receive baud rate can be modified independent of the receive modulation protocol, the transmit baud rate can be different from the receive baud rate, and the transmit modulation protocol can be different from the receive modulation protocol.

### TECHNICAL FIELD

The present disclosure relates to facsimile data transmission, and more specifically to a system and method for automatic baud rate selection for facsimile transmit and receive.

### BACKGROUND OF THE INVENTION

Equipment capable of sending and receiving faxes can encounter numerous phone-line impairments which can cause communications errors, sometimes resulting in loss of connection or even failure to establish a connection during the initial phase of a facsimile call. To complete a document transfer at that point, it is necessary to make subsequent attempts to establish or re-establish connection, which results is poor performance in terms of the time required to transfer a document. The problem with phone-line impairments is compounded if equipment is required to operate in different countries, on private telephone systems, over long distance networks, with digital voice service, or with other variables that can result in even greater time requirements to transfer documents.

### SUMMARY OF THE INVENTION

A system for automatic data rate selection is disclosed. In one exemplary embodiment, the system can include a transmit rate control that selects a transmit baud rate and a transmit modulation protocol and modifies the transmit baud rate and the transmit modulation protocol in response to communication errors. The system can also include a receive rate control that selects a receive baud rate and a receive modulation protocol and modifies the receive baud rate and the receive modulation protocol in response to communication errors. The transmit baud rate can be modified independent of the transmit modulation protocol, the receive baud rate can be modified independent of the receive modulation protocol, the transmit baud rate can be different from the receive baud rate, and the transmit modulation protocol can be different from the receive modulation protocol.

Other systems, methods, features, and advantages of the present disclosure will be or become apparent to one with skill in the art upon examination of the following drawings and detailed description. It is intended that all such additional systems, methods, features, and advantages be included within this description, be within the scope or the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for automatic baud rate selection for facsimile transmit and receive in accordance with an exemplary embodiment of the present disclosure;

FIG. 2 is a diagram of an algorithm for adjusting facsimile transmission baud rates and modulation protocol settings in accordance with an exemplary embodiment of the present disclosure;

FIG. 3 is a diagram of an algorithm for adjusting facsimile transmission baud rates and modulation protocol settings in accordance with an exemplary embodiment of the present disclosure;

FIG. 4 is a diagram of an algorithm for fallback adjustment of facsimile reception baud rates and modulation protocol settings in accordance with an exemplary embodiment of the present disclosure; and

FIG. 5 is a diagram of an algorithm for fall forward adjustment of facsimile reception baud rates and modulation protocol settings accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

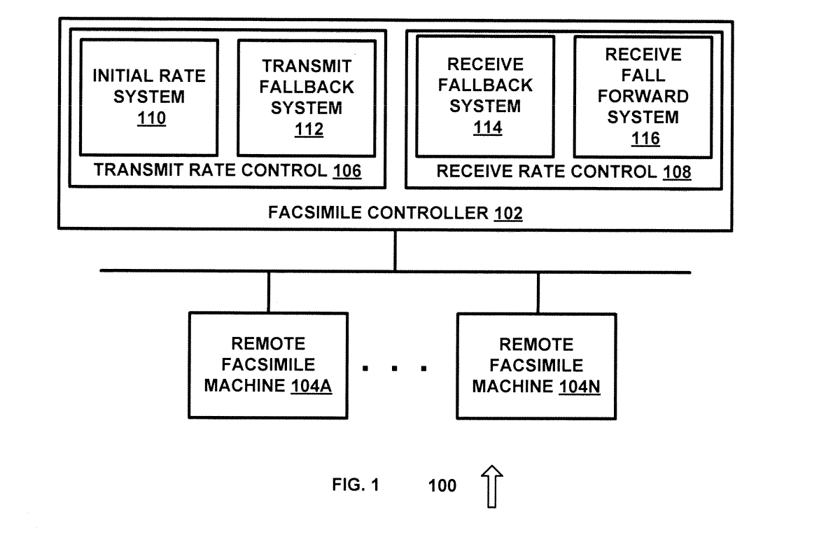

FIG. 1 is a diagram of a system 100 for automatic baud rate selection for facsimile transmit and receive in accordance with an exemplary embodiment of the present disclosure. System 100 includes facsimile controller 102, which further includes transmit rate control 106, receive rate control 108, initial rate system 110, transmit fallback system 112, receive fallback system 114 and receive fall forward system 116, each of which can be implemented in hardware or a suitable combination of hardware and software, and can be one or more software systems operating on a general purpose processing platform.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

Facsimile controller 102 controls the data transmission and reception for a facsimile machine. In one exemplary embodiment, facsimile controller 102 can select data transmission rates, data transmission modulation protocols and other suitable variables, such as based on measured or observed line parameters. For example, a remote facsimile machine 104A through 104N can send a facsimile document to a facsimile machine associated with facsimile controller 102, or the facsimile machine associated with facsimile controller 102 can send a facsimile document to one or more of remote facsimile machines 104A through 104N. The transmit baud rate, the transmit modulation protocol, the receive baud rate and the receive modulation protocol can each be selected independently, such as based on a predetermined setting, based on line conditions, based on the specific remote facsimile machine 104A through 104N that the facsimile document is being transmitted to or received from, or in other suitable manners, as discussed herein.

Transmit rate control 106 adjusts the transmit baud rate, the transmit modulation protocol and other variables in response to one or more measured variables, to decrease the time required to transmit documents. In one exemplary embodiment, the transmit baud rate, the transmit modulation protocol or other variables can be adjusted in response to a failure to transmit a facsimile resulting from a communication error, or based on other measured or observed line parameters. In another exemplary embodiment, transmit rate control 106 can adjust the transmit baud rate, the transmit modulation protocol or other variables as a function of the destination to which a document is being transmitted.

Receive rate control 108 adjusts the receive baud rate and the receive modulation protocol in response to one or more measured variables to decrease the time required to receive documents. In one exemplary embodiment, the receive baud rate, the receive modulation protocol or other variables can be adjusted in response to a failure to receive a facsimile transmission resulting from a communication error, or based on other measured or observed line parameters. In another exemplary embodiment, receive rate control 108 can adjust the receive baud rate, the receive modulation protocol or other variables as a function of the source from which a document is being received.

Initial rate system 110 sets an initial transmit baud rate, transmit modulation protocol, and other variables, such as to predetermined settings, based on the last transmission settings, or in other suitable manners, so as to decrease the time required to transmit documents. In one exemplary embodiment, initial rate system 110 can set the initial transmit baud rate, modulation protocol or other variables as a function of the destination to which a document is being transmitted.

Transmit fallback system 112 adjusts the transmit baud rate, the transmit modulation protocol or other variables in response to communications errors or other measured or observed variables to decrease the time required to transmit documents. In one exemplary embodiment, the transmit baud rate, the transmit modulation protocol or other variables can be adjusted in a fallback sequence of transmit baud rates and modulation protocols in response to a failure to transmit resulting from a communication error, or based on other measured or observed line parameters. In another exemplary embodiment, transmit fallback system 112 can adjust the transmit baud rate, the transmit modulation protocol or other variables in a fallback sequence of transmit baud rates and modulation protocols as a function of the destination to which a document is being transmitted.

Receive fallback system 114 adjusts the receive baud rate, the receive modulation protocol or other variables in response to communications errors or other measured or observed variables to decrease the time required to receive documents. In one exemplary embodiment, the receive baud rate can be adjusted in a fallback sequence of receive baud rates and modulation protocols in response to a failure to receive a facsimile resulting from a communication error, or based on other measured or observed line parameters. In another exemplary embodiment, receive fallback system 114 can adjust the receive baud rate, the receive modulation protocol or other variables in a fallback sequence of receive baud rates and modulation protocols as a function of the source from which a document is being received.

Receive fall forward system 116 adjusts the receive baud rate in response to successful communications or other measured or observed variables to decrease the time required to receive documents. In one exemplary embodiment, the receive rate can be adjusted in a fall forward sequence of transmit baud rates and modulation protocols in response to a successful reception of facsimile transmissions, or based on other measured or observed line parameters. In another exemplary embodiment, receive fall forward system 116 can adjust the receive baud rate, the receive modulation protocol or other variables in a fall forward sequence of receive baud rates and modulation protocols as a function of the source from which a document is being received.

In operation, system 100 allows a facsimile machine to be controlled to improve the time required to transmit or receive a document. In response to a communications error or other measured or observed parameters, the baud rate and modulation protocol used for transmission or reception of a facsimile can be adjusted, so as to reduce communications errors and to improve the average time required to transmit or receive a facsimile.

To minimize loss of connections and otherwise decrease the time required to transfer documents, the modulation protocol and baud rate used for communication can be optimized as a function of telecommunications line parameters. Manufacturers of facsimile transceivers allow the user to specify the transmit and receive baud rates and modulation protocols through a user interface, for the purpose of minimizing communications errors. However, most users do have the technical background to make a proper judgment as to the correct modulation protocol or baud rate to use, and also do not understand the types and levels of phone-line impairments that need to be compensated for. The phone-line impairments can also vary over time, resulting in the need to make ongoing baud rate and modulation protocol modifications, which is not practical for a user to perform.

To avoid these existing problems, the initial baud rate and modulation protocol used for facsimile transmission or reception can be set using (1) the maximum baud rate for the most advanced modulation protocol supported by the modem, (2) a specific baud rate and modulation protocol specified during product development, (3) a specific baud rate and modulation protocol specified during installation by a qualified, knowledgeable person through the user interface, or 4) other suitable systems or methods.

For each document sent, an initial baud rate and modulation protocol can be used for the first attempt to transmit the document. When communication errors (COMERR's) are encountered, a specific automated fallback sequence of incrementally lower baud rates and modulation protocols can followed for subsequent transmission attempts, such as based on the number of retry attempts or as otherwise specified by the user. For example, when less retry attempts are specified, a faster incremental fallback sequence can be used. When a sufficient number of retry attempts are used, the baud rate and modulation protocol will settle on the most robust baud rate and modulation, so as to prevent excessive attempts at higher baud rates for given modulation protocols that have already failed and which are likely to continue failing. When transmission of a given document has been completed, either successfully or not, that baud rate and modulation protocol can be used as a starting point for the next document transmission.

For receive, the initial baud rate and modulation protocol used can be determined by (1) the maximum baud rate for the most advanced modulation technique supported by the modem, (2) a specific baud rate and modulation protocol specified during product development, (3) a specific baud rate and modulation protocol specified during installation by a qualified, knowledgeable person through the user interface, or 4) other suitable means.

In the absence of prior COMERR's, the initial baud rate and modulation can be used for reception. If reception has ended unsuccessfully as the result of a COMERR, then a lower baud rate for a given modulation can be used for subsequent receive attempts. The specific fallback sequence of incrementally lower baud rates using other modulation techniques can be (1) determined during development (2) specified during installation by a qualified, knowledgeable person through the user interface, or 3) determined by other suitable systems or methods. Systems and methods for an end user to enable or disable fallback may also be provided.

When reception occurs without a COMERR, the initial baud rate and modulation protocol can be used again for subsequent receptions. In addition, systems and methods can be provided to store the identification of the transmitter associated with a received transmission, either before or after a connection is established, and the identification can be used to select an initial baud rate and modulation protocol, such as where multiple transmitters are sending to the receiver, and where some are successful while others are not. After all known transmitters with prior COMERR's have successfully completed transmission, the initial baud rate and modulation protocol can be used again. In the case where a known transmitter with prior COMERR's is not successful, a reasonable time-out period can be utilized to automatically return to the initial baud rate and modulation protocol in the absence of continued attempts by that transmitter.

The optimal transmit and receive speeds can thus be determined automatically by an algorithm implemented in the facsimile equipment. No intervention is required by the user, and therefore, the user is not required to understand how phone line parameters can affect the modulation protocol and/or baud rate that would work best given the particular set of impairments on their phone line, or to periodically analyze the phone line for changed parameters. The algorithm can continually make adjustments, minimizing communications errors so that there is no need for the user to optimize the settings.

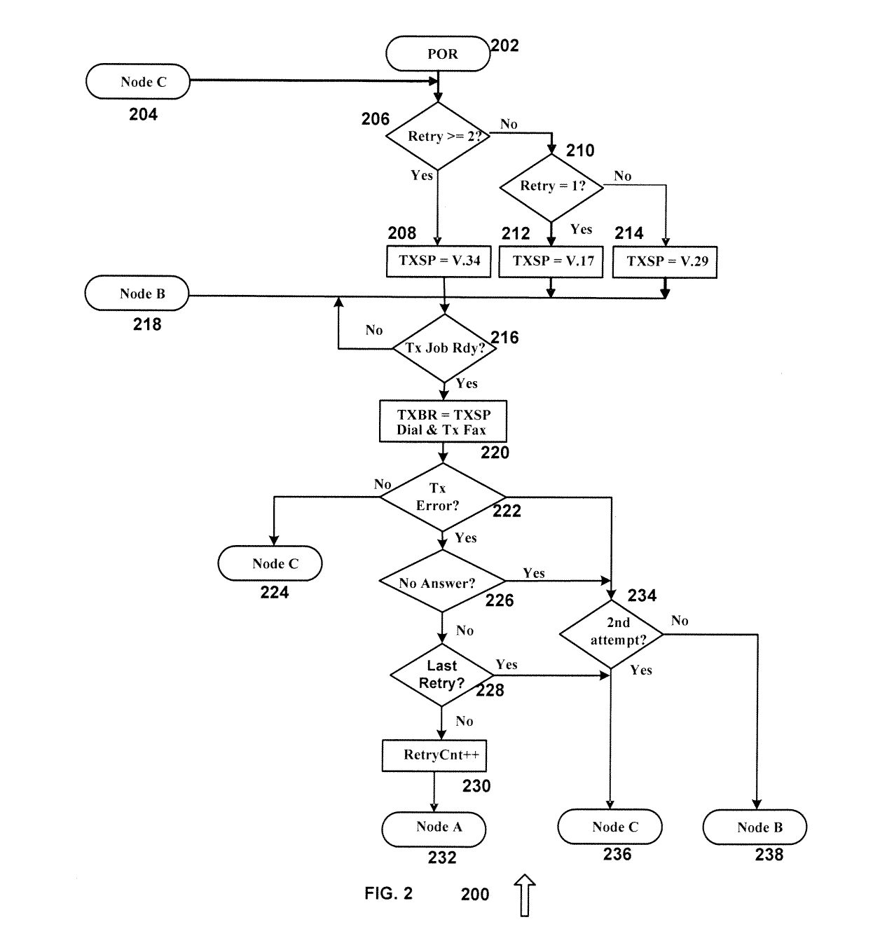

FIG. 2 is a diagram of an algorithm 200 for adjusting facsimile transmission baud rates and modulation protocol settings in accordance with an exemplary embodiment of the present disclosure. Algorithm 200 allows a system such as system 100 or other suitable electronic control systems to control facsimile transmission operations.

The value set for retries controls the initial rate and transmission protocol and the fallback pattern for facsimile transmission. Based on the retry setting and current retry attempt, a facsimile scheduler unit (ESU) such as facsimile controller 102 can determine the initial and subsequent baud rate and transmission protocol to use. The implementation of this algorithm can be hidden from the user interface and internal to the FSU. One exemplary initial baud rate, modulation protocol and fallback pattern based on retry settings is as follows:

### Retries=0:

Initial rate is V.29, 9,600

### Retries=1:

Initial modulation protocol and baud rate is V.17, 14,400
First (last) retry is V.29, 9,600

### Retries=2:

Initial modulation protocol and baud rate is V.34, 33,600 or best negotiated rate
First retry is V.17, 14,400
Last retry is V.29, 9,600

### Retries=3:

Initial modulation protocol and baud rate is V.34, 33,600 or best negotiated rate
First retry is V.17, 14,400
Second retry is V.17, 14,400
Last retry is V.29, 9,600

### Retries=4:

Initial modulation protocol and baud rate is V.34, 33,600 or best negotiated rate
First retry is V.17, 14,400
Second retry is V.17, 14,400
Third retry is V.29, 9,600
Last retry is V.29, 9,600

### Retries=5:

Initial modulation protocol and baud rate is V.34, 33,600 or best negotiated rate
First retry is V.34, 33,600 or best negotiated rate
Second retry is V.17, 14,400
Third retry is V.17, 14,400
Fourth retry is V.29, 9,600
Last retry is V.29, 9,600

### Retries=6 to n:

Initial modulation protocol and baud rate is V.34, 33,600 or best negotiated rate
First retry is V.34, 33,600 or best negotiated rate
Second retry is V.17, 14,400
Third retry is V.17, 14,400
Fourth retry is V.17, 14,400
Fifth to (n-1)^{th} retry is V.29, 9,600
Last retry is V.29, 9,600

This exemplary scheme provides an indirect speed control, because the initial modulation protocol and baud rate can be determined by the retry setting and therefore the need for a specific transmit speed control can be eliminated.

The fallback pattern can be followed when transmission failures are due to communication errors (COMERR). Special treatment can be used for the case of NO DIALTONE or BUSY. The initial modulation protocol and baud rate can be used until a connection is made. If a COMERR occurs when a connection is finally made, then the next modulation protocol and baud rate used can be the modulation protocol and baud rate in the pattern that would normally occur if there were only COMERR's. For example, when the value of the retries variable is set to 5:
Initial call at V.34, 33,600 or best negotiated rate; NO DIALTONE/BUSY
First retry is V.34, 33,600 or best negotiated rate; NO DIALTONE/BUSY
Second retry is V.34, 33,600 or best negotiated rate; NO DIALTONE/BUSY
Third retry is V.34, 33,600 or best negotiated rate; CONNECT/COMERR
skips V.17, 14,400
Fourth retry is V.29, 9,600
Last retry is V.29, 9,600

Transmission failures due to NO ANSWER will only retry one more time at the initial modulation protocol and baud rate determined by the retry setting. For example, if retries are set to 4, the single retry after NO ANSWER will be a V.34, 33,600 or best negotiated rate. If retries are set to 1, the single retry after NO ANSWER would be V.17, 14,400.

The fallback patterns could also be fine tuned by selecting lower rates within each modulation protocol. For example:

### Retries=5:

Initial modulation protocol and baud rate is V.34, 33,600 or best negotiated rate
First retry is V.34, 24,000 or best negotiated rate
Second retry is V.17, 14,400
Third retry is V.17, 12,000
Fourth retry is V.29, 9,600
Last retry is V.29, 7,200

At 202, a power on reset (POR) signal is received. The algorithm then proceeds to 206, where it is determined whether the maximum number of retries setting from the user interface is equal to or greater than 3. If the number retries is not equal to or greater than 3, the algorithm proceeds to 210, otherwise the algorithm proceeds to 208 where the transmission protocol is set to V.34.

At 210, it is determined whether the number of retries is 1. If it is determined that the number of retries is 1, the algorithm proceeds to 212 and the transmission protocol is set to V.17, otherwise, the algorithm proceeds to 214 and the transmission protocol is set to V.29.

After 208, 212 or 214, the algorithm proceeds to 216 where it is determined whether a transmit job is ready. If a transmit job is not ready, the algorithm waits until a transmit job is ready, otherwise the algorithm proceeds to 220 where the modem transmit baud rate (TXBR) is set to the selected transmission protocol and baud rate, and the facsimile is transmitted. The algorithm then proceeds to 222.

At 222, it is determined whether there has been a transmit error. If there is no transmit error, the algorithm returns to Node C at 224, otherwise the algorithm proceeds to 226 where it is determined whether there was no answer. If there was an answer, the algorithm proceeds to 228 where it is determined whether the current attempt was a last retry. If the current attempt was a last retry, the algorithm proceeds to Node C at 236, otherwise the algorithm proceeds to 230 where the retry count (RETRYCNT) is incremented. The algorithm then proceeds to Node A at 232.

If it is determined at 226 that there was no answer, the algorithm proceeds to 234 where it is determined whether this was the second attempt. If this was not the second attempt, the algorithm proceeds to Node B at 238, otherwise the algorithm proceeds to Node C at 236.

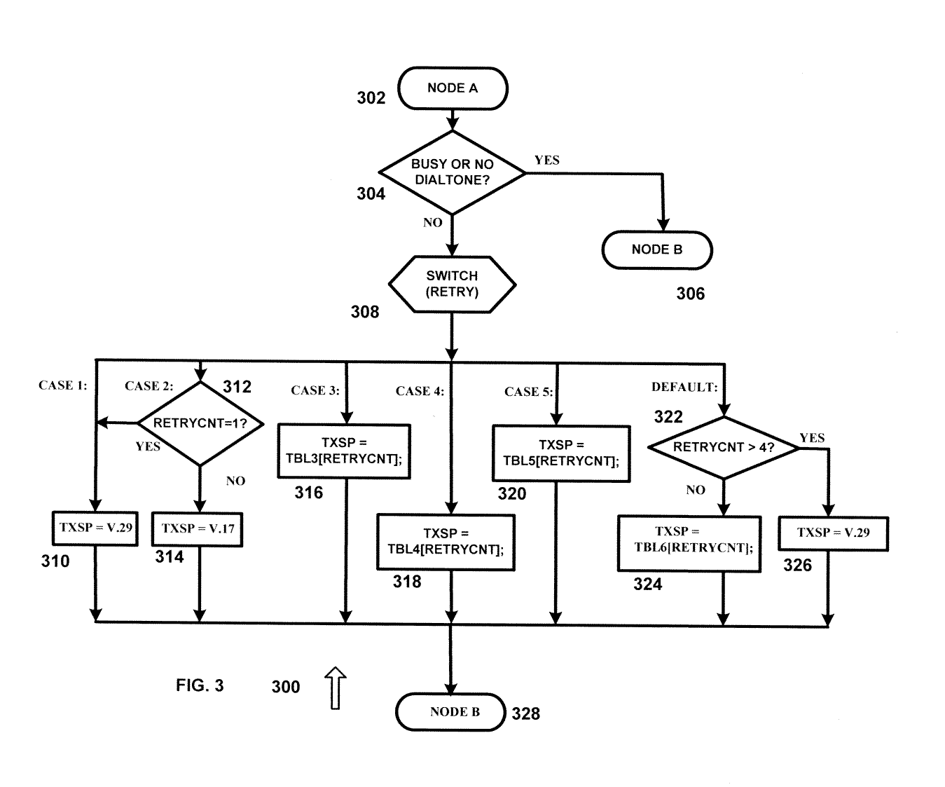

FIG. 3 is a diagram of an algorithm 300 for adjusting facsimile transmission baud rates and modulation protocol settings in accordance with an exemplary embodiment of the present disclosure. Algorithm 300 allows a system such as system 100 or other suitable electronic control systems to control facsimile transmission operations.

Algorithm 300 begins at Node A at 302 and proceeds to 304, where it is determined whether the line is busy or if there is no dial tone. If the line is busy or if there is no dial tone, the algorithm proceeds to Node B at 306, otherwise the algorithm proceeds to 308 where the number of retries, along with the retry count, is used to determine the next transmission baud rate and modulation protocol setting. In case 1, where the number of retries was set to 1, the transmit protocol is set to V.29 at 310. In case 2, where the number of retries is set to 2, if it is determined at 312 that RETRYCNT is not equal to 1, the algorithm proceeds to 314 and the transmission protocol is set to V.17. Otherwise, it is set to V.29 at 310. When the number of retries is set to 3 as in case 3 at 316, the transmission baud rate and protocol is selected as a function of the value of RETRYCNT in tb13[ ]={V.34, V.17, V.17, V.29}. When the number of retries is set to 4 as in case 4 at 318, the transmission protocol is selected as a function of the value of RETRYCNT in tb14[ ]={V.34, V.17, V.17, V.29, V.29} When the number of retries is set to 5 as in case 5 at 320, the transmission baud rate and protocol is selected as a function of the value of RETRYCNT in tb15[ ]={V.34, V.34, V.17, V.17, V.29, V.29}. At 222, when the number of retries is set to six or more, it is determined whether RETRYCNT is greater than 4. If RETRYCNT is not greater than 4, the algorithm proceeds to 324 where the transmission baud rate and protocol is selected as a function of RETRYCNT in tb16[ ]={V.34, V.34, V.17, V.17, V.17, V.29, V.29}, otherwise, the algorithm proceeds to 326 where the transmission baud rate and protocol is set to V.29. The algorithm proceeds to Node B at 328 from 310, 314, 316, 318, 320, 324 and 326.

In operation, algorithms 200 and 300 are used to select an initial baud rate and modulation protocol, and a fallback baud rate and modulation protocol pattern for outgoing facsimile transmissions. In other exemplary embodiments, suitable variations of these algorithms can be used, such as to retain in memory one or more of the recent numbers dialed and to store the speed used to successfully communicate for that number. In another exemplary embodiment, older or seldom used numbers can be replaced with newer numbers, based on available memory.

When a facsimile is being received, the receive transmission protocol and baud rate can initially be set to V.34, 33,600 bps and can remain at this setting as long as faxes can be received without COMERR's. When a call fails due to COMERR's, the receive transmission protocol and baud rate for the next call can be determined based on whether or not caller identification data (CID) was received for the call that failed.

If CID was received for the previous call, the calling name and/or number extracted from the CID and the modulation protocol and baud rate setting used for that call can be stored in memory. A timer can then be started and used to clear the stored setting information after a certain period of time expires. For example, where the initial modulation protocol and baud rate was V.34, 33,600, V.17 can be used for the next call that is received that has CID that matches the stored CID If processing the incoming call with the stored setting fails, the modulation protocol can be adjusted to V.29 and can remain there until either the timer expires, or until the processing of a call having CID that matches the stored CID is successful. Whenever processing of a call having matching CID is successful, the stored settings can be removed from memory, and subsequent calls matching that CID can be attempted at V.34, 33,600 baud.

In another exemplary embodiment, CID and the associated modulation protocol and baud rate can be retained in memory for a longer period of time, such as where a next higher speed can be used for processing incoming calls from the telephone number associated with the CID.

In the case where CID is not received, a separate, general-purpose modulation protocol and baud rate setting can be used. As with identified calls, the modulation protocol setting can initially be set to V.34 and can remain at that setting as long as facsimile transmissions from unidentified sources are received without COMERR's. When a transmission fails, the modulation protocol and baud rate can be lowered, and timer can be started that will be used to automatically restore the modulation protocol back to V.34 after a period of time has expired. Once the modulation protocol falls back to V.29, it can be held there until either the timer expires, until an unidentified call is successful, or until other suitable conditions occur.

Another exemplary variation is to store the transmitted identification (TSI) data received after the call started and use that TSI data to determine when to go back to V.34 after a successful call. This process can be used where multiple sources are calling in and one or more are calling on a bad line. In this exemplary embodiment, the modulation protocol is not reset to V.34 until one or more of the incoming calls, identified by TSI, are successful or the timer has expired.

In another exemplary embodiment, two schemes can be used with receive: a fallback scheme and fall forward scheme. With a fallback scheme, the receive modulation protocol and baud rate can initially be set to V.34, 33,600 and then the baud rate can be lowered as consecutive COMERR's occur. To minimize the amount of time required for the receive protocol/speed to converge, the maximum receive protocol/speed can fallback aggressively, but higher rates can be periodically probed so as to not settle at a low speed too quickly. To accomplish this exemplary algorithm, a running count of COMERR's for each modulation group can be stored.

For example, after a COMERR for the first call, the initial setting of V.34, 33,600 can fallback to V.17, 14,400. the second call succeeds, the receive modulation protocol can be reset to V.34 for the third call, but the running count for V.34 would be at 1. If the third call has a COMERR at V.34, the maximum receive modulation protocol will not be set to V.34 again until power is cycled. If this information is stored in NVRAM, then a reset function can also be provided to allow the information to be reset if the facsimile unit is relocated to a location with different communication lines, if the communication lines are modified, or if other suitable modifications occur.

If the second call also failed at V.17, 14,400, the receive settings can be reduced to V.29, 9,600. The counters for both V.34 and V.17 would have a value of 1. If a third call at V.29 succeeded, the receive modulation protocol would only be increased back to V.17. As in the example described above, two consecutive COMERR's at V.17 would cause the maximum receive settings to settle at V.29, 9,600.

To summarize fallback, a COMERR causes the next call to be received at the next lower protocol/rate from the protocol/rate at which the COMERR occurred. If the next call succeeds, then the protocol/rate can be bumped back up to the next higher rate again. When two calls fail at a particular baud rate, that baud rate will not be used again.

A fall forward scheme is one that starts at a modulation protocol and baud rate that will most likely work the first time. In one exemplary embodiment, V.29, 9,600 can be used receive. In another exemplary embodiment, V.17, 14,400 can be used for receive. The initial receive settings can then be adjusted up or down in the same manner as with a V.29 initial speed.

After two consecutive successful calls at V.29 without COMERRs, V.17, 14,400 can then be used as the new receive settings. If the next subsequent call experiences a COMERR, the receive settings can be set back to V.29, 9,600 and after two more consecutive successful calls, V.17 can be tried one more time. Otherwise, V.17, 14,400 can be used until two consecutive successful calls are received without COMERRs. At that point, receive settings of V.34, 33,600 or the best negotiated settings would be tried for the next call. A COMERR at V.34 can cause V.17 to be used after that until two consecutive successful calls are received. At that point, V.34 can be tried again.

To summarize, fall forward starts at a low receive setting. After two consecutive successful calls, the next higher settings are tried. If those settings fail, the algorithm falls back to the next lower settings. After two consecutive successful calls, the next higher settings are tried one more time. If that fails again, the next lower settings are selected, otherwise, an attempt is made again to increase the settings.

As with transmit, either receive scheme can be fine tuned using different baud rates in combination with a modulation protocol.

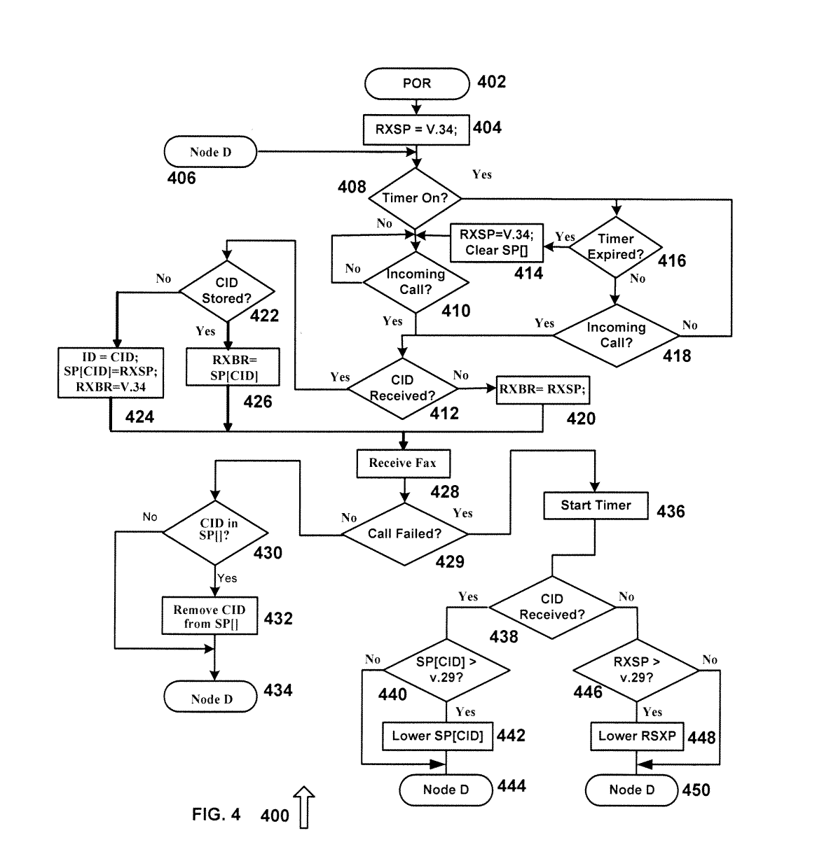

FIG. 4 is a diagram of an algorithm 400 for fallback adjustment of facsimile reception baud rates and modulation protocol settings in accordance with an exemplary embodiment of the present disclosure. Algorithm 400 allows a system such as system 100 or other suitable electronic control systems to control facsimile reception operations.

Algorithm 400 begins at 402, where a power on reset occurs. The algorithm then proceeds to 404, where the receive modulation protocol set V.34. The algorithm then proceeds to 408.

At 408, it is determined whether a timer is on. If it is determined that a timer is not on, the algorithm proceeds to 410 and waits for an incoming call. Otherwise, the algorithm proceeds to 416 where it is determined whether the timer has expired. If it is determined that the timer has not expired, the algorithm proceeds to 418, otherwise the algorithm proceeds to 414 where the value of the last failed receive speed for the CID of the caller is cleared, and the receive protocol is set to V.34. The algorithm then proceeds to 410 to await an incoming call. After an incoming call is detected at 410, the algorithm proceeds to 412.

At 418, it is determined whether an incoming call is detected. If no incoming call is detected, the algorithm returns to 416, otherwise the algorithm proceeds to 412.

At 412, it is determined whether CID has been received. If CID has been received, the algorithm proceeds to 422, otherwise the algorithm proceeds to 420, where the modem receive protocol and baud rate RXBR is set to current value of the dynamic maximum receive baud rate, RXSP. The algorithm then proceeds to 428.

At 422, it is determined whether CID has been stored that corresponds to the received CID. If CID has been stored, the algorithm proceeds to 426, where the variable RXBR is set to receive transmission baud rate and protocol as a function of SP[CID]. The algorithm then proceeds to 428. If CID has not been stored, the algorithm proceeds to 424 where an identification variable ID is set to the CID, the variable SP[CID] is set to V.34 and the variable RXBR is set to V.34. The algorithm then proceeds to 428.

At 428, a facsimile transmission is received. The algorithm then proceeds to 429, where it is determined whether the call failed. If the call has failed, the algorithm proceeds to 436, otherwise the algorithm proceeds to 430.

At 430, it is determined whether there is an CID value stored in SP[ ]. If there is no ID value, the algorithm proceeds to Node D at 434, otherwise the algorithm proceeds to 432 where the ID value is cleared from SP[ ]. The algorithm then proceeds to Node D at 434.

At 436, a timer is started. The algorithm then proceeds to 438, where it is determined whether CID has been received. If CID has been received, the algorithm proceeds to 440, where it is determined whether SP[CID] is greater than V.29. If SP[CID] is not greater than V.29, the algorithm proceeds to Node D at 444, otherwise, the algorithm proceeds to 442 where SP[CID] is lowered. The algorithm then proceeds to Node D at 444.

If CID has not been received at 438, the algorithm proceeds to 446, where it is determined whether RXSP is greater than V.29. If RXSP is not greater than V.29, the algorithm proceeds to Node D at 450, otherwise, the algorithm proceeds to 448 where RXSP is lowered. The algorithm then proceeds to Node D 450.

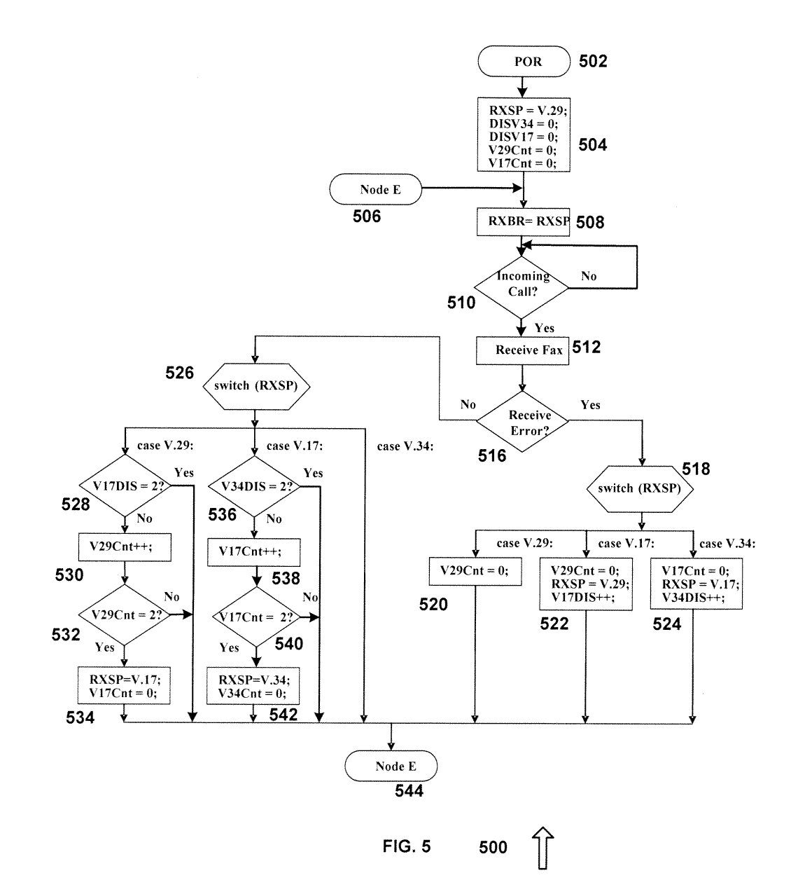

FIG. 5 is a diagram of an algorithm500 for fall forward adjustment of facsimile reception baud rates and modulation protocol settings in accordance with an exemplary embodiment of the present disclosure. Algorithm 500 allows a system such as system 100 other suitable electronic control systems to control facsimile reception operations.

Algorithm 500 begins at 502, where POR is received. The algorithm then proceeds to 504, where RXSP is set to V.29, a disable V.34 variable DISV34 is set to zero, a disable V.17 variable DIS17 is set to zero, a counter for successful calls received at V.29 V29Cnt is set to zero and a counter for successful calls at V.17 V17Cnt is set to zero. The algorithm then proceeds to 508, where RXBR is set to RXSP, and the algorithm then proceeds to 510.

At 510, it is determined whether an incoming call has been detected. If no incoming call has been detected, the algorithm loops until a call is detected, at which point the algorithm proceeds to 512, where a facsimile transmission is received. The algorithm then proceeds to 516, where it is determined whether a receive error has occurred. If a receive error has occurred, the algorithm proceeds to 518, otherwise, the algorithm proceeds to 526.

At 518, a case is selected based on the current value of receive modulation and baud rate (RXSP). If the current modulation protocol is V.29, the algorithm proceeds to 520, where the value of V29Cnt is set to zero. If the current modulation protocol is V.17, the algorithm proceeds to 522 where V29Cnt is set to zero, RXSP is set to V.29 and DISV17 is incremented. If the current modulation protocol is set to V.34, the algorithm proceeds to 524 where V17Cnt is set to zero, RXSP is set to V.17 and DISV34 is incremented. The algorithm then proceeds to Node E at 544.

At 526, a case is selected based on the current value of receive modulation and baud rate (RXSP). If the current modulation protocol is V.29, the algorithm proceeds to 528, where it is determined whether V17DIS equals 2. If so, the algorithm proceeds to Node E at 544, otherwise the algorithm proceeds to 530 where V29Cnt is incremented. The algorithm then proceeds to 532, where it is determined whether V29Cnt equals 2. If not, then the algorithm proceeds to Node E at 544, otherwise the algorithm proceeds to 534 where RXSP is set to V.17 and V17Cnt is set to zero. The algorithm then proceeds to Node E at 544.

If the current modulation protocol is V.17, the algorithm proceeds to 536 where it is determined whether V34DIS equals 2. If so, then the algorithm proceeds to Node E at 544, otherwise the algorithm proceeds to 538 where V17Cnt is incremented. The algorithm then proceeds to 540 where it is determined whether V17Cnt equals 2. If not, then the algorithm proceeds to Node E at 544, otherwise the algorithm proceeds to 542 where RXSP is set to V.34 and V34Cnt is set to zero. The algorithm then proceeds to Node E at 544.

If the current modulation protocol is V.34, then the algorithm proceeds to Node E at 544.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for automatic data rate selection comprising:
a transmit rate control for initially selecting a transmit baud rate and a transmit modulation protocol and for modifying the transmit baud rate and the transmit modulation protocol in response to communication errors; and
a receive rate control for initially selecting a receive baud rate and a receive modulation protocol and for modifying the receive baud rate and the receive modulation protocol in response to communication errors;
wherein the transmit baud rate can be modified independent of the transmit modulation protocol, the receive baud rate can be modified independent of the receive modulation protocol, the transmit baud rate can be different from the receive baud rate, and the transmit modulation protocol can be different from the receive modulation protocol.

2. The system of claim 1 further comprising an initial transmit baud rate system for applying a predetermined transmit baud rate and a predetermined modulation protocol for facsimile transmission of a first document.

3. The system claim 1 further comprising a transmit fallback system for applying a predetermined sequence of transmission baud rates in response to facsimile document communication errors.

4. The system of claim 1 further comprising a transmit fallback system for applying a predetermined sequence of modulation protocols in response to facsimile document communication errors.

5. The system of claim 1 wherein the transmit rate control is for selecting the transmit baud rate and the transmit modulation protocol as a function of the destination to which a facsimile of a document is being transmitted.

6. The system of claim 1 wherein the receive rate control is for selecting the receive baud rate and the receive modulation protocol as a function of the source from which a facsimile of a document is being received.

7. A method for automatic data rate selection comprising:
selecting a predetermined transmit baud rate and a predetermined transmit modulation protocol;
selecting a predetermined receive baud rate and a predetermined receive modulation protocol independently from the predetermined transmit baud rate and the predetermined transmit modulation protocol; and
modifying the transmit baud rate and the transmit modulation protocol after encountering a communication error in transmitting data without modifying the receive baud rate and the receive modulation protocol.

8. The method of claim 7 further comprising modifying the receive baud rate and the receive modulation protocol after encountering a communication error in receiving a facsimile document without modifying the transmit baud rate and the transmit modulation protocol.

9. The method of claim 7 wherein selecting the predetermined transmit baud rate and the predetermined transmit modulation protocol comprises selecting the predetermined transmit baud rate and the predetermined transmit modulation protocol as a function the destination which facsimile document is to be transmitted.

10. The method of claim 7 wherein selecting the predetermined receive baud rate and the predetermined receive modulation protocol comprises selecting the predetermined receive baud rate and the predetermined receive modulation protocol as a function of the source from which a facsimile document is to be received.

11. The method of claim 7 further comprising modifying the receive baud rate after encountering a communication error in receiving a facsimile document without modifying the transmit baud rate and the transmit modulation protocol.

12. The method of claim 7 further comprising modifying the receive modulation protocol after encountering a communication error in receiving a facsimile document without modifying the transmit baud rate and the transmit modulation protocol.

13. The method of claim 7 further comprising modifying the transmit baud rate and the transmit modulation protocol after transmitting a facsimile document if a communication error has not been encountered.

14. The method claim 7 further comprising increasing the transmit baud rate after transmitting facsimile document if a communication error has not been encountered.

15. The method of claim 7 further comprising increasing a counter for a modulation protocol if a communication error has been encountered.

16. The method of claim 7 further comprising increasing a counter for the receive modulation protocol if a communication error has been encountered receiving a facsimile document.

17. The method of claim 7 further comprising increasing a counter for the transmit modulation protocol if a communication error has been encountered transmitting a facsimile document.

18. The method of claim 7 further comprising increasing a retry counter if a communication error has been encountered while transmitting a facsimile document.

19. The method of claim 7 further comprising:
increasing a transmit retry counter if a communication error has been encountered while transmitting a facsimile document; and
increasing a receive retry counter if a communication error has been encountered while receiving a facsimile document.

20. A method for automatic data rate selection comprising:
selecting a predetermined transmit baud rate and a predetermined transmit modulation protocol;
selecting a predetermined receive baud rate and a predetermined receive modulation protocol independently from the predetermined transmit baud rate and the predetermined transmit modulation protocol;
modifying the transmit baud rate and the transmit modulation protocol after encountering a communication error in transmitting a facsimile document without modifying the receive baud rate and the receive modulation protocol;
increasing a transmit error counter after encountering the communication error in transmitting the facsimile document;
modifying the receive baud rate and the receive modulation protocol after encountering a communication error in receiving a facsimile document without modifying the transmit baud rate and the transmit modulation protocol; and
increasing a receive error counter after encountering the communication error in receiving the facsimile document.
